(19) United States
(12) Patent Application Publication
(10) Pub. No.: US 2003/0184477 A1
(43) Pub. Date: Oct. 2, 2003

(54) Phased array antenna steering arrangements

(76) Inventors: Lotfollah Shafai, Winnipeg (CA); Cyrus Shafai, Winnipeg (CA)

Correspondence Address: DARBY & DARBY P.C., P. O. BOX 5257, NEW YORK, NY, 10150-5257, US

(21) Appl. No.: 10/112,136

(22) Filed: Mar. 29, 2002

(51) Int. Cl. H01Q 1/38

(52) U.S. Cl. 343/700 MS

(57) ABSTRACT

An electronically-steered phased array antenna comprises a plurality of antenna elements, each in the form of a resonant structure, and circuitry for changing resonance frequencies of the antenna elements so as to steer a radiation or reception beam/lobe of the phased array antenna. The antenna elements may comprise a plurality of microwave patch antenna elements each overlying one of a plurality of conductive membranes, but spaced therefrom. The resonance frequency then is changed by flexing the membrane, conveniently by applying a potential difference between the membrane and an adjacent ground plane. Additional or alternatively, phase shifting may be effected by adjusting a propagation delay of each of a plurality of feed lines coupled to the antenna elements, conveniently by means of one or more such membranes disposed adjacent each of the feed lines.

### DESCRIPTION

1. Technical Field

This invention relates to steering arrangements for phased array antennas, especially electronically scanned phased array antennas.

2. Background Art

In telecommunications, radar surveillance and remote sensing, for example, it is known to use a high gain, phased array antenna whose antenna radiation/sensitivity beam/lobe is scanned over a coverage area. While mechanically movable platforms, such as gimbals and turntables, can be used to alter the aimpoint of the high gain antenna in several axes, they normally are bulky and, consequently, costly to manufacture and operate.

Electronic scanning generally is preferred because it does not require moving parts. Instead, a phase shifter or delay line is interposed between two adjacent antenna elements in the array so as to introduce a relative phase difference between them. Adjusting the phase shift between their individual radiated fields will cause the beam radiated by the array antenna to scan. The effect is similar whether the array antenna is used for transmission or reception. Hence, adjusting the phase shifters of a reception array antenna will cause the array radiation or sensitivity lobe to be oriented to the direction from which the desired signal is arriving so as to receive the maximum signal from that direction.

Ferrite or solid-state phase shifters are the most common means of generating the inter-element phase shift in electronically scanned array antennas. Ferrite phase shifters perform better at high frequencies, but are more expensive to implement and operate than solid-state phase shifters. The latter are more convenient and less expensive to implement and operate, but have limited power level. This is especially true for analog phase shifters. Also, digital solid-state phase shifters introduce increasingly higher resistive losses when used for higher microwave and millimetre bands. Consequently, phased array antennas have not found much application in commercial programmes.

The flexibility of phased arrays for antenna beam control makes them desirable for commercial applications and has led to a search for alternative means of generating inter-element phase shifts or beam scanning. Hybrid mechanical and electronic systems have been introduced, where the array beam is scanned electronically in one plane and beam steering in a second plane is provided mechanically, conveniently by placing the array on a turntable. In applications where beam scanning as a function of frequency is required, it is known to use a simple delay line to feed the array elements serially, as disclosed by M. Li and K. Chang in an article entitled “Novel low-cost beam steering techniques using microstrip patch antenna arrays fed by dielectric image lines”, IEEE Transactions on antennas and Propagation, Vol. 47, pp. 453-457, March 1999. Such an approach, however, will not be useful for telecommunications where signals having different frequencies in a finite frequency band must be transmitted together, thus requiring the means for controlling beam direction to be independent of frequency.

A proposed remedy for the problems associated with high frequency resistive losses of phase shifters and the high cost of components suitable for use at high frequencies is disclosed by John H. Long in U.S. Pat. No. 6,266,011, issued July 2001. Long's system uses the difference between the signal and control frequencies to generate the phase shifts, and thus scan the beam by changing the control frequency. While this system might be simpler to operate, it would not be entirely satisfactory because it would still suffer from the above-mentioned limitations of solid-state phase shifters and also require complementary microwave circuitry to implement the array.

An object of the present invention is to at least ameliorate the problems associated with such known antenna arrays, or at least provide an alternative.

### DISCLOSURE OF INVENTION

According to one aspect of the present invention, a phased array antenna comprises a plurality of antenna elements and control means for changing a resonance frequency of one or more of the antenna elements so as to steer a radiation or reception beam/lobe of the phased array antenna.

Preferably, the control means includes means for effecting a dimensional change in the antenna element and/or between the antenna element and an associated ground plane.

The control means may comprise a plurality of conductive membranes, each of the plurality of antenna elements overlying a respective one of the plurality of membranes, preferably with a space therebetween, and means for causing flexing of each membrane to alter the resonance frequency of the associated one of the plurality of antenna elements.

Each membrane may act as a ground plane for the overlying antenna element. Alternatively, the membrane may be provided in addition to a ground plane.

Preferably, each of the plurality of antenna elements is coupled to a respective one of a plurality of feedlines, and the control means further comprises means for altering one or more of the feedlines so as to change propagation delays of signals propagating therein, preferably by changing physical dimensions of or between the or each feedline and/or between the or each feedline and an associated ground plane.

The invention also embraces an arrangement for steering a phased array antenna by adjusting physical dimensions of one or more of the feedlines and/or between each feedline and an associated electrode, for example an associated ground plane so as to change the propagation delay, rather than adjusting the antenna elements themselves.

Hence, according to a second aspect of the invention, there is provided a phased array antenna comprising a plurality of antenna elements each coupled to a corresponding one of a plurality of feed lines, and control means for effecting such a dimensional change of one or more of the feed lines and/or between one or more of the feedlines and an associated electrode, for example an associated ground plane, as to cause a change in propagation delay of signals propagating in the or each feed line and thereby steer a radiation or reception beam/lobe of the phased array antenna.

Where the control means alters the feedlines so as to change the propagation delay, it may comprise a plurality of additional membranes, one or more of which are associated with the feed line(s).

The feedlines may comprise microstrip feedlines or dielectric feedlines.

According to a third aspect of the invention, a phased array antenna comprises a plurality of antenna elements each coupled to a corresponding one of a plurality of feed lines and control means for effecting a dimensional change so as to steer a radiation or reception beam/lobe of the phased array antenna, the dimensional change being such as to change a resonance frequency of one or more of the antenna elements or to change propagation delay of signals propagating in the or each feed line.

The dimensional change may be in or between parts of the antenna element itself, such as between the antenna element and an associated ground plane. Additionally or alternatively, the dimensional change may be between one or more of the feedlines and an associated electrode, for example an associated ground plane.

### BRIEF DESCRIPTION OF THE DRAWINGS

Embodiments of the invention will now be described by way of example only and with reference to the accompanying drawings in which:

FIG. 1 is a block schematic diagram of a first embodiment of the invention in the form of a phased array antenna having four antenna elements and associated feed lines with underlying membranes;

FIG. 2 is a detail sectional side view of one of the antenna elements;

FIG. 3 is a plan view of the antenna element;

FIG. 4 is a sectional side view of a section of feedline having two membranes underlying it;

FIG. 5 is a plan view of the section of feedline and membranes of FIG. 4;

FIGS. 6 and 7 are sectional views of two alternative configurations of membrane;

FIG. 8 is a block schematic diagram of a two-dimensional array antenna comprising several of the phased array antennas of FIG. 1; and

FIG. 9 is a graph illustrating variation in radiation phase angle with respect to antenna resonance frequency.

### DETAILED DESCRIPTION OF PREFERRED EMBODIMENTS

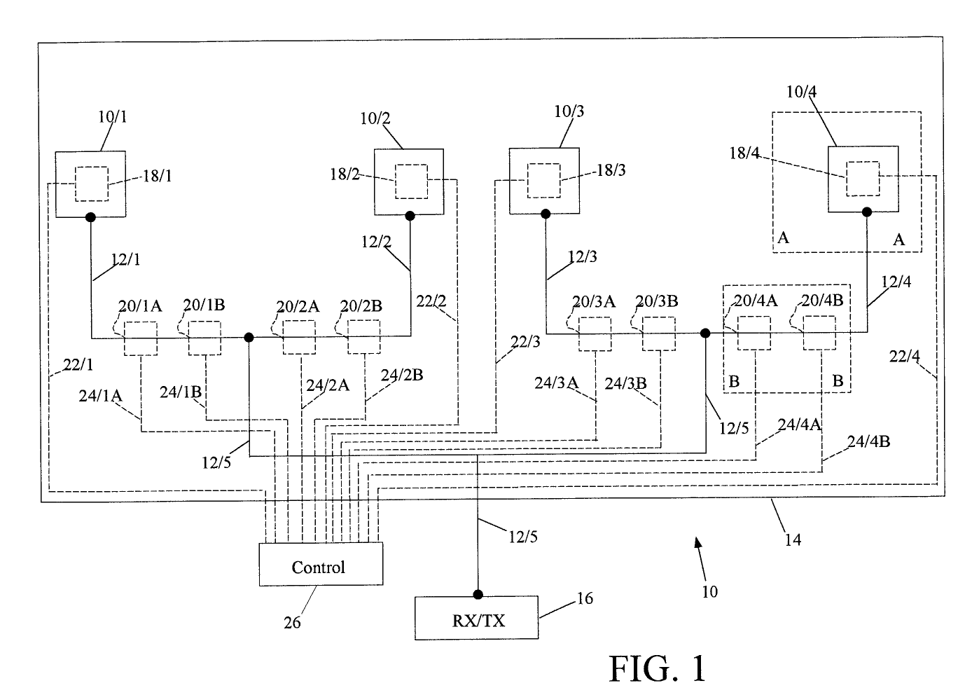

Referring to FIG. 1, a phased array antenna 10 comprises an array of four antenna elements 10/1, 10/2, 10/3 and 10/4, each comprising a microstrip patch antenna element, coupled to four feed lines 12/1, 12/2, 12/3 and 12/4, respectively, which comprise microstrip transmission lines; all mounted upon a multilayer printed circuit board 14. An additional feed line 12/5 connects the four feed lines 12/1, 12/2, 12/3 and 12/4 in common to a transmitter or receiver (TX/RX) 16. For the purposes of description, it will be assumed that the phased array antenna is used to transmit signals, but it will be appreciated that it could be used to receive signals too.

Each of the patch antenna elements 10/1, 10/2, 10/3 and 10/4 overlies a respective one of a first group of four control units 18/1, 18/2, 18/3 and 18/4. A second group of four pairs of control units 20/1A;20/1B, 20/2A;20/2B, 20/3A;20/3B, and 20/4A;20/4B, are disposed beneath the feed lines 12/1, 12/2, 12/3 and 12/4, respectively. The first and second groups of control units 18/1, . . . ,18/4 and 20/1A, . . . ,20/4B are coupled by two groups of separate control lines 22/1, . . . , 22/4 and 24/1A, . . . , 24/4B, respectively, to a controller 26 which adjusts them selectively, conveniently by means of D.C. control signals, to effect beam steering. The controller 26 and the plurality of control units 18/1, . . . , 18/4 and 20/1A, . . . , 20/4B constitute a control system for steering the phased array antenna 10.

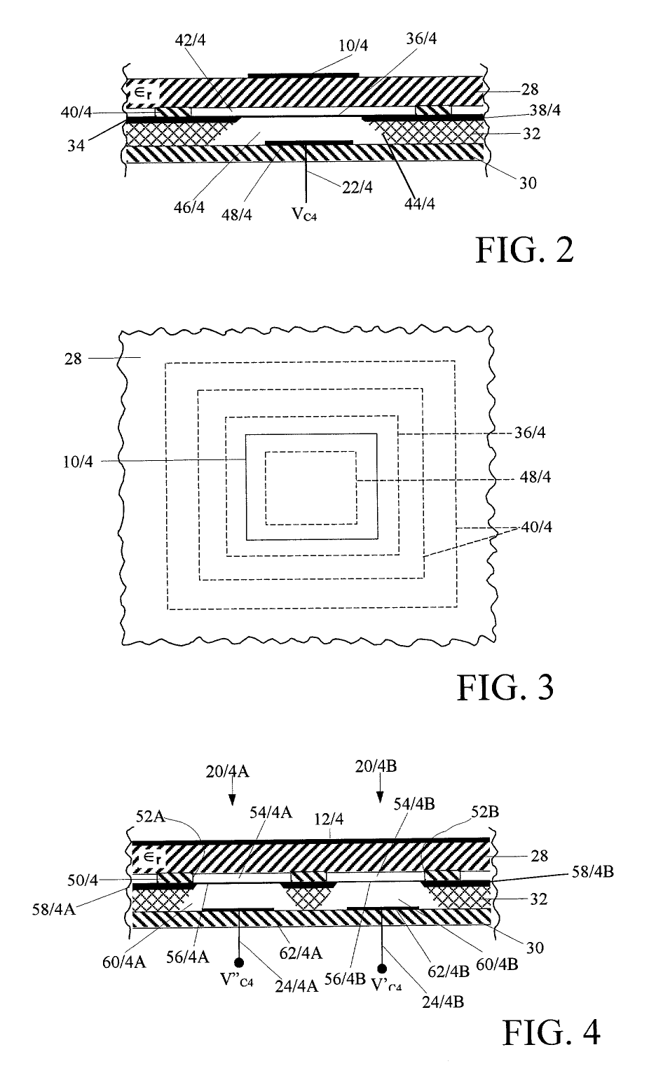

The first group of control units 18/1, . . . , 18/4 are substantially identical in construction, so only one of them, control unit 18/4, will now be described in more detail with reference to FIGS. 2 and 3. The multilayer printed circuit board 14 comprises an uppermost dielectric layer 28, a lowermost dielectric layer 30, and a middle dielectric layer 32. The materials used for the layers may be whatever is suitable for the fabrication process to be used. For example, if chemical etching (micromachining) is to be used, the layer may be glass. Alternatively, if numerically controlled machining is used, the layers might be other insulating material, such as a combination of Teflon and fiberglass, as marketed under the trade mark DUROID. A ground plane 34 is provided upon the uppermost surface of the middle dielectric layer 32 and has a plurality of thinner membrane portions 36 and thicker marginal portions 38, as will be described in more detail later.

The microstrip patch element 10/4 is formed upon the surface of uppermost dielectric layer 28. For convenience of illustration, the feed line 12/4 coupling the antenna element 10/4 to the receiver/transmitter 16 is not shown.

A rectangular portion of the conductive ground plane 34 having a very thin central membrane portion 36/4 and thicker margins 38/4, extends subjacent the dielectric substrate 28 and is spaced from its lower surface by a thin rectangular spacer 40/4 having a central opening leaving a narrow air gap 42/4 between the underside of the dielectric substrate 28 and the membrane portion 36/4. The membrane portion 36A may be a thin metal film, such as copper, or a dielectric film with thin metallisation layers on its opposite surfaces.

The ground plane 34 lies upon the upper surface of the second or middle dielectric layer 32 which itself is supported by the third, lowermost dielectric layer 30. The second dielectric layer 32 has a central rectangular opening 44/4, conveniently formed by chemical etching or micromachining, forming a cavity 46/4 extending between the underside of the membrane portion 36/4 and the upper surface of the lowermost dielectric layer 30.

A plate electrode 48/4, conveniently formed by metallisation, is provided within the cavity upon the upper surface of the lowermost dielectric layer 30.

The plate electrode 48/4 is connected by way of control line 22/4 (see also FIG. 1) to the beam steering controller 26 which applies a control voltage V_{C4} between the plate electrode 48/4 and the ground plane 34, and hence the conductive membrane portion 36/4. When the control voltage V_{C4} is applied, the resulting electrical force between the plate electrode 48/4 and the membrane portion 36/4 causes displacement of the membrane portion 36/4 towards to the electrode 48/4, thereby increasing the thickness of the air gap 42/4 between the membrane portion 36/4 and the underside of the uppermost dielectric substrate 28. This reduces the effective permittivity of the substrate beneath the microwave patch antenna element 10/4 and increases its resonance frequency. Consequently, the radiated field of the patch antenna element 10/4 experiences an electrical phase change, the magnitude of which is proportional to the displacement of the membrane portion 36/4, and therefore dependent upon the magnitude of the control voltage V_{C4}.

Of course, a converse arrangement could be used, with the membrane portion 36/4 being drawn away from the electrode 48/4 and decreasing the thickness of the air gap 42/4.

It should be noted that the spacer 40/4, and the air gap 42/4 it creates, are optional. The membrane 36/4 could lie directly against the dielectric substrate 28 and be drawn away from it to create the change in resonance frequency.

Air holes may be provided in the lowermost dielectric substrate 30 and/or the uppermost dielectric substrate 28, so as to avoid pressure or vacuum effects resisting movement of the membrane 36/4.

Applying different control voltages to the different membrane portions 36/1 . . . 36/4 results in corresponding different phase shifts of the respective radiated fields of the antenna elements, and thus causes the beam radiated by the array antenna to scan. The process is reciprocal, i.e., when the microstrip patch antenna elements each receive a signal, displacement of the membranes 36/1, . . . , 36/4 by the control voltages V_{C1}, . . . , V_{C4} will cause an electrical phase shift at their output terminals.

It should also be noted that the dielectric layers 28 and 32 and the ground plane 34, with membranes 36, separate the circuitry for applying the control voltages V_{C1}, . . . , V_{C4} electrically from the radio frequency circuitry of the microwave patch antenna elements and their feed lines. Hence, there is an inherent isolation between the control and radio frequency signals, improving the reliability and reducing the cost of implementation.

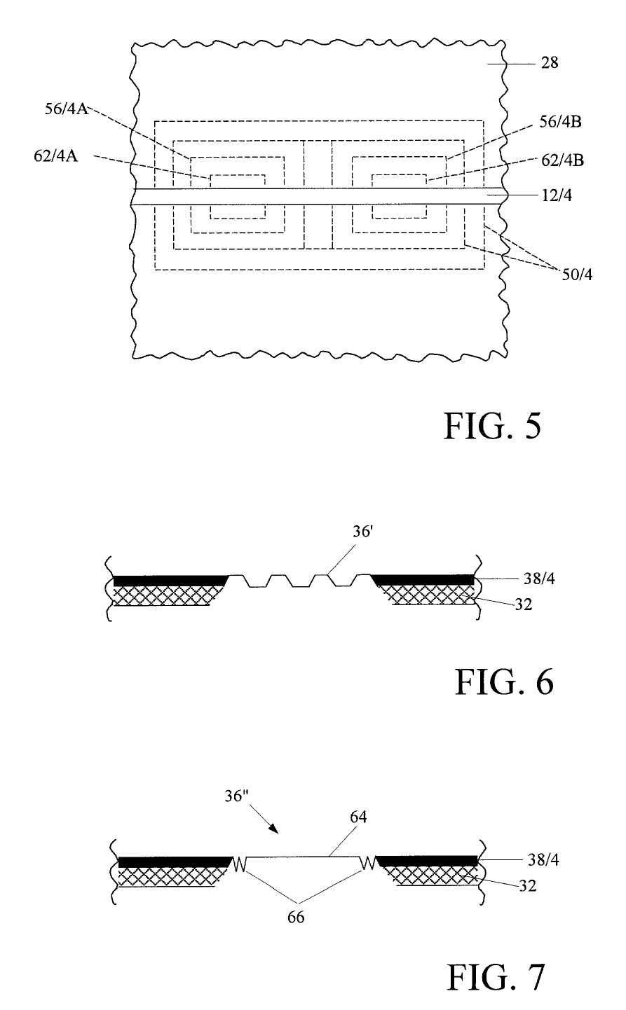

Referring again to FIG. 1, the phase control units 20/1A, 20/1B, . . . , 20/4A, 20/4B beneath the feedlines 12/1 . . . 12/4, respectively, may be used to adjust the phase velocities of the signals in, or propagation delays of, the feedlines. This allows the phase shift for each antenna element to be increased, with a concomitant increase in the range over which the array beam can be deflected. The feed line phase control units are similar so only one will be described in more detail with reference to FIGS. 4 and 5.

The feed line phase control units 20/4A and 20/4B shown in FIGS. 4 and 5 are a pair, but each of them is generally similar to that shown in FIGS. 2 and 3 in that the feed line 12/4 is formed on the uppermost surface of the first dielectric substrate layer 28. The ground plane 34 extending adjacent the underside of the dielectric layer 28 is spaced from it by a rectangular spacer 50/4A having two rectangular holes 52/4A and 52/4B, respectively, leaving air gaps 54/4A and 54/4B respectively, in line with the superjacent feed line 12/4.

The ground plane 34 has two, thin conductive membrane portions 56/4A and 56/4B, which register with holes 52/4A and 52/4B, and thicker margin portions 58/4A and 58/4B. The second dielectric layer 32 has two openings forming cavities 60/4A and 60/4B in register with the membrane portions 56/4A and 56/4B, respectively. Hence, there are air gaps above and below the membrane portions.

Plate electrodes 62/4A and 62/4B are provided within the cavities 60/4A and 60/4B, respectively, conveniently by metallisation upon the uppermost surface of the dielectric layer 30. The plate electrodes 62/4A and 62/4B are connected to the controller 26 (FIG. 1) by separate control lines, respectively, whereby control voltages V_{C4}′ and V_{C4}″ may be applied. As before, application of the control voltages V_{C4}′ and V_{C4}″ to the plates electrodes 62/4A and 62/4B causes the membrane portions 54/4A and 54/4B to deflect, changing the width of the air gaps and hence the relative permittivity of the dielectric beneath the feed line, thereby controlling the phase delay introduced by that portion of the feed line, and changing the phase velocity of the feed. The phase delay is in series with that introduced by the microwave patch antenna element 12/4 itself and thus increases the phase difference between the array elements and, consequently, the beam scan range. Also, when the voltages V_{C4}′ and V_{C4}″ are applied and controlled separately, the phased array beam can be scanned in finer steps, but over a larger range. This arrangement also permits implementation of more advanced hybrid analog and digital phase shift algorithms, adding flexibility and enhanced performance without experiencing the difficulties of analog solid-state phase shifters.

It should be appreciated that only one membrane could be used beneath each feedline, rather than two; or even more membranes could be added.

Also, the spacers 40/4; 50/4 could be integral with each other and/or with either the upper dielectric layer 28 or the lower dielectric layer 32 (with holes in the ground plane, as appropriate), or the thicker margin portions 38/4, 58/4A, 58/4B of the membraneous ground plane 24/4. Although the membranes 36/1, . . . 36/4 and 56/1A . . . 56/4B shown in FIGS. 2, 3, 4 and 5 are flat, other configurations are feasible. For example, FIG. 6 shows a corrugated membrane 36′, and FIG. 7 shows a membrane 36″ having a flat middle section 64 and a corrugated margin 66. In either case, the corrugations allow the membrane to move without necessarily stretching. Thus, these and other suitable configurations could be used to increase the allowable range of membrane displacement, thus enabling larger phase shifts by either or both of the microstrip patch antenna element and the associated feed lines or a greater range of operating frequencies where the membrane is used to tune the antenna.

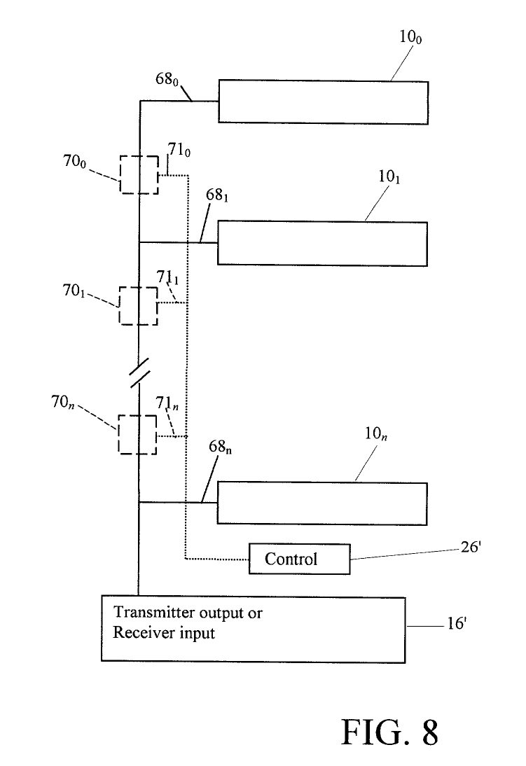

FIG. 8 shows how several phased array antennas 10₀, 10₁, . . . , 10ₙ, each similar to the antenna element 10 of FIG. 1, can be combined into a two-dimensional array. A receiver (or transmitter) 16′ is coupled to the antenna arrays by feed lines 68₀, . . . , 68ₙ, respectively. Although they are not shown in FIG. 8, each of the antenna arrays 10₀, 10₁, . . . , 10ₙ will have internal membranous control units as shown in FIGS. 1 to 6. Additional membranous control units 70₀, . . . , 70ₙ are provided adjacent the feedlines 68₀, . . . , 68ₙ and coupled to the control unit 26′ by control lines 71₀, . . . , 71ₙ, respectively.

It should be noted that the feed lines 68₀, . . . , 68ₙ could be connected in parallel or series to the antenna arrays 10₀, . . . , 10ₙ. In the former case, each of the membranous control units 70₀, . . . , 70ₙ would be associated with a respective one of the feed lines whereas, in the latter case, the feed line would run over each of the membranous control units 70₀, . . . , 70ₙ in turn and the membranous control units 70₀, . . . , 70ₙ would be between a pair of the antenna arrays 10₀, . . . , 10ₙ.

Because the feed line for each of the linear arrays 10₀, . . . , 10ₙ passes over at least one membranous control unit, the beam control unit 26′ can provide phase control in the direction normal to the planes of the individual arrays, allowing the beam to be steered/scanned in both azimuth and elevation.

It should be noted that the additional control units 70₀, . . . , 70ₙ need not be membranous control units but could be conventional phase shifters.

The invention is predicated upon the fact that most array antenna elements, such as microwave patches and dipoles, are resonant structures and generate phase shifts in dependence upon the operating frequency. It is possible, therefore, to scan/steer the array beam by preferentially modifying the resonant frequency of the individual antenna elements. The required modifications can be made possible by micromaching the microstrip patch, or its ground plane, and then using DC voltages to implement the geometrical modifications. These geometrical modifications may be the change of the patch size, its distance from the ground plane, the location of its feed, the introduction of a shorting pin between the patch and its ground plane, or any other change which would effect the required change in resonance frequency.

A microstrip patch antenna has a second order resonance. As is known in circuit theory, such a structure will have a second order transfer function and generate up to 180° of phase shift between its input and output signals. For the transmitting antenna, the input signal is the applied source signal and the output signal is its radiated field. Thus, by changing the resonance frequency of the microstrip patch, up to 180° in phase shift can be generated in its radiated field. Similarly, considerably more than 180° phase shift in the radiated field can be generated by stacking two microstrip patches one upon the other, connecting the feed line to one of them, and leaving the other patch “floating”. Both patches would be affected by displacement of the membrane.

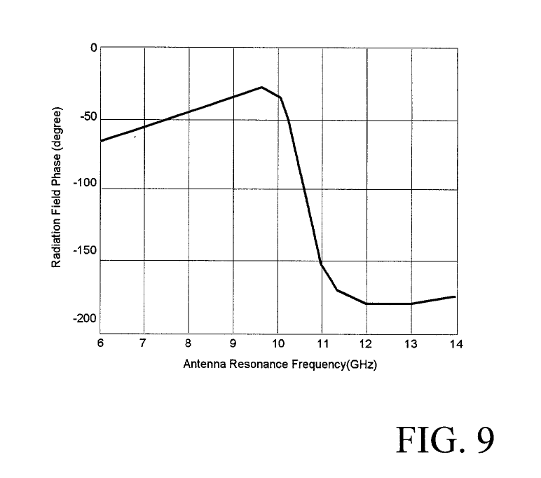

FIG. 9 illustrates, as an example, the relationship between the radiated field phase and the antenna resonance frequency for a patch antenna 10 carried by a substrate 28 having a dielectric constant of about 4, and shows that the phase changed substantially linearly by about 150 degrees while the resonance frequency changed from about 10 GHz to about 11 GHz. This change was obtained by deflecting the membrane portion 36 by about one millimeter on average. (N.B. The membrane portion 36 will deflect non-uniformly across its width)

In a similar fashion, the variable phase delays in the microstrip feed line can be generated by changing the effective permittivity of the microstrip line. If the microstrip feed substrate has a thin air gap over the ground plane, changing the air gap thickness can modify the effective permittivity of the microstrip substrate, and thus change the phase delay introduced by the microstrip line. The amount of change in the signal phase delay will depend upon the line length, substrate permittivity and the change in its air gap.

In a phased array antenna made of resonant structures, such as microstrip patches that are fed by microstrip delay lines, the change in the array element resonance frequency and the phase delay due to its feed line can be combined to generate up to 360° of phase shift to scan the array beam throughout the entire physical space.

It should be noted that it would be possible to move the antenna (or feed line) instead of, or in addition to, the membrane in order to effect the change in the resonance frequency. It should be appreciated that the invention is not limited to movement of a membrane beneath the antenna element or feedline to effect the change in resonance frequency. Rather, the invention embraces making any other physical change in, or movement of, one or both of the antenna element/feed line and associated ground plane to produce the required change in resonance frequency of the antenna element or propagation delay (phase velocity) of the feed line. For example, the feed lines themselves could be replaced by probes, slots, electromagnetically-coupled lines, or other suitable coupling components.

The antenna elements could be dipoles or other suitable elements whose equivalent circuit is a tuned circuit.

Although adjustment of the propagation delay of a feed line is described herein with reference to a microstrip transmission line, it should be appreciated that it could be applied to other kinds of feed line, such as dielectric feed lines.

The control means may be configured to apply a multiplicity of different voltages to the membranes, respectively, so as to permit hybrid-digital beam scanning.

It is envisaged that the antenna elements could be conventional, passive elements and only the feedlines provide the beam steering, using embodiments of the present invention.

It should be appreciated that, because the adjustment of the membrane associated with an antenna element changes its resonance frequency as well as the radiated field phase, the bandwidth of the antenna element should be larger than the narrowband transmitted/received signal by an amount, perhaps several times larger, so that the (fixed) narrowband frequency of the signal remains within the (moving) antenna bandwidth.

It is envisaged that this change in resonance frequency caused by a change in the physical dimensions could be used to adjust the frequency of an individual antenna element, in which case it would not matter that the radiated field phase changed as well. Such a frequency-tunable antenna element is the subject of a U.S. Provisional patent application No. ______ (Attorney's docket number AP930USP) filed simultaneously herewith.

### INDUSTRIAL APPLICABILITY

Embodiments of the invention advantageously avoid losses caused by ferrite phase shifters or solid-state devices. The specific embodiment has a very low power consumption, as compared with ferrite phase shifters and solid-state devices, which is important for mobile or extraterrestrial applications. Also, embodiments of the invention can be fabricated using techniques or processes similar to those used to create integrated circuits or/and microstrip antennas.

1. A phased array antenna comprising a plurality of antenna elements and control means for changing a resonance frequency of one or more of the antenna elements so as to steer a radiation or reception beam/lobe of the phased array antenna.

2. A phased array antenna according to claim 1, wherein the control means comprises means for effecting a physical change in either the antenna element or an adjacent ground plane, or therebetween.

3. A phased array antenna according to claim 1, wherein the control means comprises a plurality of membranes, each of the antenna elements overlying a respective one of the plurality of membranes, and means for effecting a change in spacing between each antenna element and associated membrane.

4. A phased array antenna according to claim 1, wherein the control means comprises means for effecting a physical change in either the antenna element or an adjacent ground plane, or therebetween and wherein the control means comprises a plurality of membranes, each of the antenna elements overlying a respective one of the plurality of membranes, and means for effecting a change in spacing between each antenna element and associated membrane.

5. A phased array antenna according to claim 3, wherein each membrane comprises at least part of a ground plane.

6. A phased array antenna according to claim 1, further comprising a plurality of feed lines each coupled to a respective one of the antenna elements, and wherein the control means further comprises means for adjusting a propagation delay of each of the feed lines.

7. A phased array antenna according to claim 6, wherein the control means comprises means for effecting a physical change in either the feedline or an adjacent ground plane or therebetween.

8. A phased array antenna according to claim 6, wherein the means for adjusting propagation delay comprises a plurality of membranes, one or more of which are associated with each of the feed lines, and means for displacing each of the membranes to alter the propagation delay of the associated one of the feed lines and phase velocity of signals propagating therein.

9. A phased array antenna according to claim 1, wherein the plurality of antenna elements comprise a plurality of patch antenna elements coupled to a plurality of feed lines, respectively, and the control means comprises a plurality of conductive ground plane membranes, each of the plurality of patch antenna elements overlying a respective one of the plurality of membranes, and each of the feed lines extending across one or more of the plurality of membranes, the phase control means further comprising means for flexing each membrane to alter the resonance frequency of the associated one of the plurality of antenna elements.

10. A phased array antenna according to claim 9, wherein the means for flexing each membrane comprises circuitry for applying a potential difference between the membrane and an associated electrode so as to deflect the membrane electrostatically relative to the electrode.

11. A phased array antenna according to claim 9, wherein at least one of the membranes associated with a feedline comprises a first portion and a second portion and the control means is arranged to deflect the first and second portions independently of each other.

12. A phased array antenna according to claim 9, wherein the means for flexing each membrane comprises circuitry for applying a potential difference between the membrane and an associated electrode so as to deflect the membrane electrostatically relative to the electrode and wherein at least one of the membranes associated with a feedline comprises a first portion and a second portion and the control means is arranged to deflect the first and second portions independently of each other.

13. A phased array antenna according to claim 1, wherein the membrane comprises a flexible metal film.

14. A phased array antenna according to claim 1, wherein the membrane comprises at least one conductive coating on a surface of a flexible insulating/dielectric film.

15. A phased array antenna according to claim 1, wherein the membrane is non-planar.

16. A phased array antenna according to claim 15, wherein the membrane is corrugated.

17. A phased array antenna according to claim 15, wherein the membrane has a flat middle portion and corrugated marginal portion.

18. A phased array antenna according to claim 1, wherein the control means comprises means for applying different control voltages to the different antenna elements, thereby to cause a beam of the phased array antenna to scan.

19. A phased array antenna according to claim 15, wherein the antenna elements are arranged in a linear array and the control means comprises means for applying a continuously variable control voltage to said membranes so as to cause continuous scanning of a beam of the phased array antenna.

20. A phased array antenna according to claim 18, wherein the antenna elements are arranged in a plurality of linear arrays stacked to form a two-dimensional array, and the control means comprises means for applying different voltages to different antenna elements so as to allow a beam of the antenna to be scanned in elevation and azimuth.

21. A phased array antenna comprising a plurality of antenna elements each coupled to a respective one of a plurality of feed lines, and control means for changing a propagation delay of each of one or more of the feed lines so as to steer a radiation or reception beam/lobe of the phased array antenna.

22. A phased array antenna according to claim 21, wherein the control means comprises means for effecting a physical change in either the feedline or an adjacent ground plane or therebetween.

23. A phased array antenna according to claim 22, wherein the control means comprises a plurality of membranes, one or more of which are associated with each of the feed lines, and means for displacing each of the membranes to alter the propagation delay of the associated one of the feed lines and phase velocity of signals propagating therein.

24. A phased array antenna comprising a plurality of antenna elements each coupled to a corresponding one of a plurality of feed lines and control means for effecting a dimensional change so as to steer a radiation or reception beam/lobe of the phased array antenna.

25. A phased array antenna according to claim 24, wherein the dimensional change is such as to change a resonance frequency of one or more of the antenna elements or to change propagation delay of signals propagating in the or each feed line.

26. A phased array antenna according to claim 24, wherein the dimensional change is of a part of the antenna element itself and changes a resonance frequency of the antenna element.

27. A phased array antenna according to claim 24, wherein the dimensional change is between the antenna element and an associated ground plane and changes a resonance frequency of the antenna element.

28. A phased array antenna according to claim 24, wherein the dimensional change is between one or more of the feedlines and an associated ground plane and changes a propagation delay of the feedline.
